(19) United States
(12) Patent Application Publication
(10) Pub. No.: US 2013/0346137 A1
(43) Pub. Date: Dec. 26, 2013

(54) PARTICIPATORY METHOD AND SYSTEM FOR APPLICATION AND PROJECT MANAGEMENT

(71) Applicant: Blue Planet Run Foundation, Redwood City, CA (US)

(72) Inventor: Rajesh SHAH, Oakland, CA (US)

(73) Assignee: BLUE PLANET RUN FOUNDATION, Redwood City, CA (US)

(21) Appl. No.: 14/012,052

(22) Filed: Aug. 28, 2013

Related U.S. Application Data
(63) Continuation of application No. 12/530,614, filed on Mar. 3, 2010, now abandoned.
(60) Provisional application No. 60/894,430, filed on Mar. 12, 2007.

(51) Int. Cl. G06Q 10/06

(52) U.S. Cl. CPC G06Q 10/06313
USPC 705/7.23

(57) ABSTRACT

Provided herein are a methods and a system for implementing a participatory mechanism for selecting of applications, overseeing implementation and progress of projects, monitoring and evaluation of completed projects. The method provides a mechanism for managing projects which involve flexible and hard to quantify outcomes. The method provides a mechanism for managing long-term projects of variable length that require long-term monitoring. The method provides a mechanism for managing projects where human input is essential. The method provides a mechanism to handle a large number of applications for a large number of projects. The method provides a rational method for managing a large number of projects with a large diversity (e.g., hard to replicate projects.)

### CROSS-REFERENCE

This application is a continuation of application Ser. No. 12/530,614, filed Sep. 9, 2009, which claims priority to International Application No. PCT/US2008/056553 filed in the U.S. Receiving Office on Mar. 11, 2008, which claims priority to U.S. Provisional Application No. 60/989,063, filed on Mar. 12, 2007, each of which is incorporated by reference in its entirety.

### BACKGROUND OF THE INVENTION

Unsafe drinking water kills 6000 people a day, 250 children under five an hour, and fills up half the world's hospital beds. In addition, the daily toil of fetching water causes extreme misery to, mainly, women and girls. Solutions proven to work in rural villages are small projects involving a transfer of knowledge, a change in ownership, a change in behavior, training, customization, cultural sensitivity and with long-term monitoring. Due to the current funding structure, process, resources, and metrics, we have not been able to take the few successful pilots and scale up to change the global trend of increasing water scarcity.

Today it is estimated that more than 50% of water projects fail, less than 5% are visited upon completion and less than 1% are visited after a year. In order to meet the Millennium Development Goals to halve the number of people without access to safe drinking water by 2015, we need to select, fund, manage, and monitor tens of thousands of diverse, dispersed water and sanitation projects. This is not possible with the current process which has the following drawbacks:
Funders' bureaucracy to oversee foreign projects prevents working on systemic issues;
Implementers waste valuable resources on fundraising instead of implementing;
Learning opportunities are missed because only positive results are reported;
Monitoring is not a learning and sharing experience;
Implementers focus on individual interests without cooperating; and
The lack of transparency impacts funding and public perception.

The global community has been facing the water problem for decades. The challenge has been how to manage thousands of small, diverse water and sanitation projects worldwide. In particular scaling and managing a large number (millions) of small projects has been the unassailable problem in development for decades.

The last several decades have seen undeniable technological progress that has positively impacted the global community. However, exclusive focus on technology is not suitable for solving problems that involve non-uniform problems such as lack of safe water in poor and remote areas. Each community is faced with specific problems that cannot be solved using technology-only based approaches. In fact, the trend has been to take out specificity and human intervention as the scale of the problem and participants increase. This approach cannot solve problems such as providing safe water to vastly varied communities.

There is a need for methods and systems that increase the incorporation of experiences of the participants, especially the failures and lessons from them. The desired methods should leverage technology to increase human implication in refining models and providing a knowledge base that increases as the number of participants increases.

Particularly needed are methods and systems wherein implementers' core competency and field experience are used more effectively and efficiently to solve the problem of scale, while the funders' bureaucracies are broken down to allow the funders to concentrate on their core competency of raising money and work on system-wide issues.

The global community is in need of funding, implementation and evaluation systems that maximize accountability, transparency, and communication increase while the bureaucracy to select, manage, monitor, and evaluate projects decreases. Increased public confidence equals increased funding.

There is also a need for methods that are implemented to empower the human element across the field, giving decision-making information and power to all the remote nodes of the global human network working on solving various aspects of a global tragedy at a local level.

There is still a need for methods that reduce costs, foster cooperation, and facilitate knowledge sharing. Desirable methods would help scale the work to the need and also provides ready access to world leaders, funders, grassroots implementers, and ordinary citizens around the world enabling them, for example, to see the size of the global safe drinking water problem and the work going towards solving it.

### SUMMARY OF THE INVENTION

The present invention provides a method and system for implementing a participatory mechanism for selecting of applications, overseeing implementation and progress of projects, monitoring and evaluation of completed projects. The method provides a mechanism for managing projects which involve flexible and hard to quantify outcomes. The method provides a mechanism for managing long-term projects of variable length that require long-term monitoring. The method provides a mechanism for managing projects where human input is essential. The method provides a mechanism to handle a large number of applications for a large number of projects. The method provides a rational method for managing a large number of projects with a large diversity (e.g., hard to replicate projects).

The method is built based on scalability which allows the processing, managements and monitoring of projects at a global scale both in terms of geographic spread and number of participants. The invention contemplates the processing of hundreds of thousands of applications and the management of hundreds of thousands of projects at the same time.

The method and system of the invention provide tools that allow for optimum use of the participants expertise—in fact, it allows for increased participation from increased number of participants. By minimizing the efforts devoted to fundraising, the invention allows participants to devote almost all their time and resources for the success of the projects. By focusing on project implementation, the participants' expertise is increased, exponentially. Increased participant expertise benefits the entire network of peers through experience sharing. It is contemplated that the sharing of knowledge from hundreds of thousands of projects ultimately leads to greatly efficient and beneficial processes with maximum positive community impact.

While the methods and systems of the invention are based on participant input in a peer to peer mechanism whereby experiences are equally processed in forming the knowledge databases; the invention allows for the inclusion of non-participant expertise. Specialized expertise is injected at very low weights so that the knowledge base is dominated by participant experiences and lessons learned.

The invention provides streamlined and shared systems for project selection; monitoring and evaluation. The systems of the invention eliminate the need for formal and attractive applications and glossy or biased reporting. The invention integrates reporting as part of the implementation process thereby incorporating the reporting activities as a learning process. By providing standard and automatic reporting, the invention reduces the effort required and facilitates knowledge formation and harnessing.

One aspect of the method of the invention involves the formation of a network of self selected, self-managed and self regulated network of operators who are involved in related activities around which the projects are built. The method of the invention is mainly based on collective determinations in selecting projects for funding and/or implementation; funding the projects; monitoring the progress of the projects and evaluating the outcomes associated with the projects. The network is formed through peer nominating; peer review and peer selection.

The method and system of the invention involve an engine including the following modules:
i) Submission module
ii) Review module
iii) Reporting module
iv) Monitoring and Evaluation module
v) Assignment module
vi) Nomination module
vii) Communication module
viii) Learning module
ix) Mapping module

The core engine also includes a number of databases including:
i) Finance database
ii) Application database
iii) Project database
iv) Organization and people databases
v) Interaction database
iii) Knowledge repository

The core engine is linked to an administration interface for populating the databases and processing and updating information provided by the peers in a network. The system of the invention includes customized and specialized user interfaces including:
i) Large Donor interface
ii) General Donor interface
iii) Application interface
iv) Reviewer interface
v) Project interface
v) Evaluation interface
vi) Public interface

In embodiments relating to the selection, funding, monitoring and evaluation of projects, the invention involves an application submission step. The applicant, for example a non-governmental organization (NGO), will submit a project by logging in to a dedicated portal. The applicant would provide information through the Implementer interface. The information is processed through the submission module. The applicant would select a project name. Through the interface, the applicant indicates the focus of the proposed project. The applicant also provides the location of the proposed project. The invention provides for a flexible tool for the applicant to provide a variety of background information. The system then queries about specific information in connection with the project. Specific information includes:
a. cost of the project,
b. technology to be used or developed in conjunction with the project.
c. community organization aspects that will be implemented in conjunction with the project
d. population impact (e.g., number of people impacted)
e. community contribution
f. long-term maintenance plan and costs
g. revenue model
h. visual aids and documents (e.g., photos, narrative files, spreadsheets, etc)
i. the background of the other parties involved

In the selection phase, all partners are assigned a list of projects to review. The assignment can be based on a number of criteria including, but not limited to:
a. number of applications submitted by any particular applicant
b. amount of funding requested by any particular applicant
c. the size and capacity of an applicant
d. a pre-determined minimum number of reviews per application required
e. geographic diversity and similarity of reviewers required
f. language considerations
g. varied background of reviewers (implementers, funders, observers, etc.)
h. history of reviews and participation
i. randomization factors

The review process will include interaction and question and answer exchanges; comments on improving the approach; partners then rate the applications quantitatively and qualitatively for funding.

Once the projects have been selected and implementation is started, implementers will provide progress reports and/or final results. The reports are provided in a standardized format. A standard report includes the following information:
a. Project name
b. Focus
c. Location
d. Implementer
e. Date the project was started
f. Date the project was completed
g. People impacted
h. Final cost
i. Technology used or developed in connection with the project
j. Maintenance costs
k. Revenue
l. Miscellaneous issues
m. Narrative
n. Learnings from the project
o. Photos
p. Other reports (water quality results, documents, and spreadsheets)

During the monitoring and evaluation phase the method provides tools for assigning projects to participants to review based on a variety of factors:
a. Number of projects undertaken
b. Amount of funding received
c. Volunteer interest
d. Travel plans
e. Geography
f. History of reviews
g. Randomization factors

During the monitoring and evaluation phase the method provides tools for compiling experiences learned and tools for sharing the learned experiences. In particular the method contemplates the organization of conferences attended by participants to facilitate the sharing of experiences learned and providing an easy forum for the monitoring partners to meet with the implementer.

One advantageous feature of the method of the invention is the ability of the funding partners, observer partners, and public at large to monitor progress of the projects.

The flexibility of the process of the invention allows for refining the selection process by implementing lessons learned from prior cycles of selection, implementation, monitoring and evaluation.

Due to the presence of a broad review process, the method contemplates the reporting of failures since the consequences of explaining poor performance to a jury of peers as a learning experience is unlikely to be as bad as the consequences of reporting poor performance to a single person at a funding entity.

The method of the invention includes evaluation of each participant by their peers and by the system using data from their:
a. Participation (qualitative and quantitative) in reviews
b. Reporting on their projects
c. Monitoring and evaluation of other projects
d. Referring other people and organizations to be members of the network
e. Performance of the referred participants

### DETAILED DESCRIPTION OF THE INVENTION

The present invention provides a solution to the problem facing the water community for decades: how to manage thousands of small, diverse water and sanitation projects worldwide. Implementers' core competency and field experience are used to select, manage, monitor, and evaluate projects while the funders' expertise is used to raise money, monitor the overall process, and work on system-wide issues. Organizations submit applications for water and sanitation projects, their peers then interactively critique, improve, and rate these applications. Averages of peer ratings determine funding. Implementer, observer and funder organizations are all encouraged to participate in the process of reviewing projects, along with any interested parties.

The global community benefits from PWX because accountability, transparency, and communication increase while bureaucracy decreases. Increased public confidence means increased funding.

The present invention is based at least in part on the presupposition that grassroots projects involving a transfer of knowledge, a change in ownership, a change in behavior, training, customization, cultural sensitivity, and long-term monitoring provide a solution for many global problems. However, scaling and managing these small projects has been the unassailable problem in development for decades. One specific problem addressed by the methods and systems of the invention relates to the fact that 1.2 billion people do not have access to safe drinking water—resulting in filling up half the world's hospital beds. Due to water shortages, over 6,000 people are dying every day, with over 250 children under five dying every hour.

The method of the invention provides methods, systems and processes to raise money for water projects effectively, in part through Peer Water Exchange (PWX) program to manage the funding and scale. The methods of the invention solve the problem of nominating, selecting, managing, and evaluating hundreds of thousands and even millions of diverse village level water and sanitation projects around the world with a fixed minimal overhead cost regardless of the number of projects to be managed.

The invention uses on-line technologies to standardize processes and bring together grassroots implementers across the world to share their expertise and experience and to participate in efficiently and transparently managing thousands of projects. The invention is based in part on the realization that a computer network is more robust, efficient, and powerful than any single centralized mainframe and the translation of these concepts to human organizations. New technologies, including internet based technologies can connect, enable, and empower field experts to replace a centralized bureaucratic funding process. The invention provides systems that scale up funding and managing thousands of projects to reverse the growing trend of people without access to safe drinking water.

The present invention provides a novel funding and management model based on:
Facilitating participatory decision-making for selecting and funding water projects;
Reducing overhead during project review, selection, and evaluation;
Encouraging sharing and learning between organizations (increasing South-South dialog);
Using a map-based system that increases cooperation and coordination;
Managing and evaluating project performance long after completion;
Increasing transparency of the entire systems: from funding decisions to project results; and
Dramatically increasing the resources (human and financial) to successfully tackle the problem of safe drinking water at virtually no cost.

The systems of the invention are designed to help three constituencies. First, the funders whose philanthropic investments can reach their maximum potential as overheads come down dramatically and more money reaches the grassroots.

Funders can:
move away from managing small projects to monitoring a system;
focus on their core competency: fundraising;
foster cooperation among grantees;
use a new application and project management system to connect with donors;
see their funding scale up to actually reduce the global problem.

The methods of the invention establish participatory decision-making system. Implementers—normally at the receiving end of a very hierarchical relationship—can participate in funding decisions, review proposals of other organizations, share knowledge and monitor projects. The advantages for implementers are to:
reduce the amount of resources used in fundraising;
use standardized forms to reduce application time;
simplify and standardize project management;
leverage their field experience to select and evaluate their peer's water projects;
develop and use a new dynamic water knowledge management system;
see their work as part of a larger system that addresses the global problem.

The methods and systems of the invention provides invaluable advantages to populations in need of safe water, whose numbers decrease as the number of projects initiated increase and the success rate goes up. Since water projects are often the tip of the iceberg of work that involves sanitation, hygiene, education, community organization, and reforestation, there are many other benefits received.

The invention aims at fundamentally transforming the way philanthropy is practiced and social change projects are implemented globally. The way applications are accepted is standardized and simplified—content becomes more important than appearance. Instead of a central bureaucracy reviewing applications, a vast network of field experts get to make decisions—reviewing, selecting and monitoring the projects that should be funded, based on the submissions from their peer community, thus enabling and empowering them (the people who best understand the grassroots water problems) to make the most informed decisions. Questions from the other field peers help improve the application, fostering learning and knowledge sharing. The costs of making such decisions goes down as the field experts do the work in lieu of fundraising and instead of less than 50% of the money reaching the field, more than 95% of funding reaches projects.

Methods and systems of the invention are designed to benefit the global community. It becomes stronger as more funders use the system to channel their funds. As the number of partner organizations multiply, resources to handle the load do the same. The network becomes more vibrant, robust, and efficient as its use increases and the number of members grows.

The methods of the invention can be implemented based on existing and future technologies. In one embodiment, Ruby on Rails was used in building one aspect of the invention. Rails is a full-stack web framework for developing database-backed web applications. Rails was selected for implementing one aspect of the invention at least in part based on the appreciation that Rails-based projects thrive on the Agile approach to software development and project management and execution and the framework itself facilitates this approach. Rails implements the MVC (Model-View-Controller) paradigm in a very clean manner and allows the various modules of the system to be well partitioned and easily manageable. The invention can be beneficially implemented using Rails as Ruby's DSL (Domain Specific Language) features allowed implementation of new features, like Search and File Attachments, to the existing application with minimal changes to the core of the application. Other technologies such as mapping technologies provided by Google maps, have been integrated into the application. Extensions with GPS phones and field testing kits with transmitters will be built as the . . .

As discussed above, the invention contemplates a variety of user tailored interfaces to facilitate communication and reporting in connection with evaluation and monitoring of the projects. The invention contemplates customized interfaces for linking an evaluator (e.g., a peer, a funder or a third party observer) to the databases associated with the project he is visiting for evaluation and monitoring. The interface facilitates downloading of specific data about the project, including access to the project location through Google map for example. The interface will allow the evaluator to upload images taken through a camera and as well as enter results of tests conducted using a test kit (e.g., water quality tests). In one embodiment of the invention, the interface is suitable for use in through a cellular phone.

In addition, as important as the technology, the methods and systems of the invention are sufficiently flexible to mimic the ideas behind the technology—e.g., that a network approach is better than a centralized system. The human activities addressed by the methods of the invention are designed using the network approach. This combination of technology and organization is the creative force to tackle global problems.

The methods and systems of the invention provide several advantages including a network operating model and visual display of both applications and projects. The present invention relies on the knowledge that organizations bring to the table and proves that expertise from the field leads to superior decision-making The invention is based in part on the realization that experience and practices and participatory decision-making ultimately provide evolving systems that are perfected by the common experience of the participants.

The invention is based on an approachable management model system that includes not only participating organizations (implementers, funders and observers), but anyone with access to the internet to partake. An interactive map enables anyone to see which projects are currently underway, where organizations are located, and what applications have been submitted in the past. During the review phase of a funding cycle, we encourage comments and questions on the Question/Answer forum from all parties to inspire further dialog between partners.

The invention allows the formation of a knowledge-base, showing both successes and failures, both best practices and pitfalls as it gets used. There is no need to enter data and create and format case studies—the work itself provides the study.

The methods and systems of the invention can become operational in an extremely short time with very few resources. While many modules in project management, finance, and performance evaluation need to be built (see Appendix 3), the application submission, review, and rating process is fully functional. The map-based management interface provides many advantages for all stakeholders.

The method of the invention allows for implementation using cutting edge open source technology in addition to implementation using proprietary vendor solution. This allows taking advantage of the open source community to add features to the application.

The methods and systems of the invention are also advantageous in that they are based on a balance of the load between computers and humans—The methods do not require automating everything and do not diminish the non-automated aspects. The methods are implemented to empower the human element across the field, giving decision-making information and power to all the remote nodes of the global human network working on solving various aspects of a global tragedy at a local level. The methods of the invention reduce costs, foster cooperation, and facilitate knowledge sharing. The invention helps scale the work to the need and also provides ready access to world leaders, funders, grassroots implementers, and ordinary citizens around the world, enabling them to see the size of the global safe drinking water problem and the work going towards solving it.

The methods and systems of the invention are not limited to water related projects. It is contemplated that the methods and systems of the invention will provide advantages in connection with any project that can benefit from grassroots participation and wherein large numbers of participants can be leveraged to improve the delivery of services by capitalizing on human participation. Other than water, many other global problems that require a social change, education and/or a transfer of knowledge can be tackled by implementing the methods and systems of the invention. For example, the invention can be implemented in connection with problems that have solutions, but not the right management systems in place. The invention provides a novel approach to tackle other global problems such as climate change, hunger, AIDS prevention, and others that require the implementation of many small customized projects, with community interaction and involvement: projects that are not easy to scale and reproduce.

For example, in the context of projects to decrease the impact of global warming, the methods of the invention are particularly suitable for managing thousands of small climate mitigation projects globally while minimizing impact on the environment associated with selecting, funding, managing and evaluating projects aimed at reducing carbon dioxide emissions. By implementing community based project selection and monitoring, the methods of the invention allow for monitoring projects without the need for travel and the related contributions to the problem of global warming. By involving a network of millions of participants who are directly involved in evaluation and monitoring there is no need for bureaucratic structures that make monitoring and evaluation impractical. Also, by having the community involved in the evaluation and monitoring transparency is increased and the possibility for fraud is reduced. An emissions trade system where in the entire community is involved encourages participation by those in the developed areas, where energy consumption is the highest as they will have confidence that their contributions to environment friendly projects will actually be implemented and that their contribution to reducing the global warming problem will actually be implemented. The methods and systems of the invention are particularly suitable for implementing effective global warming related projects at least in part based on the scalability of the methods and systems which allows for staring with a relatively small number of projects (e.g., 100) and scaling up to millions of projects thereby providing a meaningful impact on the environment.

Another aspect for implementing the methods and systems of the invention involves college education and applicant selection. This aspect also capitalizes on the scaling up capabilities provided by the methods and systems of the invention. College student selection is limited currently limited by the resources involved in selecting student applicants. The number of application reviewers is generally limited to a few dozens. In view of the interconnectivity of global communities, colleges would benefit greatly by expanding their pool of applicants. The current systems however do not allow for efficient and cost effective evaluation of hundreds of thousands of potential candidates. The methods of the invention allow for a network of reviewers formed by peer applicants. The network can be supplemented with current students and alumni students. Others may be added to the network for providing particular expertise. By forming a network of applicants, current students and alumni who are themselves involved in the selection process, the methods and systems of the invention allow a more transparent process. The interactivity between the participants allows for selection of the incoming student class based on peer evaluation.

While the present invention is described in the context of an embodiment employing a button for referral, it is contemplated that all means that would allow a referrer to facilitate the subscription of a referred subscriber are within the scope of the invention.

Embodiments of the invention are illustrated in the appended drawings and charts.

While preferred embodiments of the present invention have been shown and described herein, it will be obvious to those skilled in the art that such embodiments are provided by way of example only. Numerous variations, changes, substitutions, and applications will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1.-53. (canceled)

54. A computer implemented method to distribute a fund into smaller awards for a selected number of projects and to manage the reporting of the results of the projects; wherein the method is effected through a peer-to-peer network and the method comprises:
(1) collecting information regarding an application for each project;
(2) distributing the applications submitted to a subset of peers for review;
(3) allowing questions, answers, suggestions, and comments for each application;
(4) allowing the submission of a rating based on numerical set of scores and comments by peers for each application
(5) generating a report wherein said report contains:
(a) the project application;
(b) the questions and the responses;
(c) the rating by each reviewer; and
(d) a statistical analysis of all the ratings in combination with the ratings of the reviewers.

55. The method of claims 54 wherein forming the peer network comprises:
selecting a seed group of peers, wherein each member of the seed group nominates one or more new peers;
rating each nominated peer based on evaluations provided by at least two members in the seed group;

56. The method of claim 55, wherein the rules of peer evaluation are established by the participant peers.

57. The method of claim 54 wherein rules of project evaluation and monitoring are established by the participant peers.

58. The method of claim 54 wherein the number of projects is at least 1000.

59. The method of claim 54 wherein the number of projects is at least 1000000.

60. The method of claim 54 wherein the applications assigned to a peer reviewer are determined based on one or more of the following criteria:
minimum number of reviews for each peer
the number of applications submitted by the reviewer peer
based on the total grant requested by each reviewer peer
based on size/capacity of organization to which the reviewer peer belongs
based on historical participation of the reviewer peer and the reviewer peer's organization
value of contributions of the reviewer peer
minimum number of reviews per application required
geographic diversity and similarity of reviewers required
language considerations
role of the peer (implementers, funders, observers, etc.)
randomization factors to eliminate bias.

61. The method of claim 54 wherein a review weight is applied to selected review peers.

62. The method of claim 54 further comprising a statistical analysis of all the ratings in combination with the ratings of the reviewer themselves based on criteria including:
feedback rating by peers/reviewers
level of effort in the review process
quality of contribution
helpfulness.

63. The method of claim 54 wherein the reviewing peer is selected based on one or more of the following criteria:
determined number or fraction of projects that need to be evaluated
minimum number of reviews for each peer
the number of projects funded for each peer
the total amount allocated to the peer's projects
convenience and geographical proximity
unrelated travel plans of the reviewing peer
size/capacity of organization to review
historical participation of the reviewer peer
role of peer (implementer, funder, observer)
previous evaluation reports on the project
randomization factors to eliminate bias.

64. A system for implementing a computer implemented method to distribute a fund into smaller awards for a number of projects and to manage the reporting of the results of the projects; wherein the method is effected through a peer-to-peer network and the system comprises a core engine including the following modules:
i) Submission module
ii) Review module
iii) Reporting module
iv) Monitoring and Evaluation module
v) Assignment module
vi) Nomination module
vii) Communication module
viii) Learning module
ix) Mapping module

65. The system of claim 64 wherein then core engine further includes a number of databases comprising:
i) Finance database
ii) Application database
iii) Project database
iv) Organization and people databases
v) Interaction database
iii) Knowledge repository

66. The system of claim 64 wherein the core engine is linked to an administration interface for populating the databases and processing and updating information provided by the peers in a network.

67. The system of claim 64 wherein the system comprises customized and specialized user interfaces including:
i) Large Donor interface
ii) General Donor interface
iii) Application interface
iv) Reviewer interface
v) Project interface
v) Evaluation interface
vi) Public interface

68. The system of claim 64 Wherein during the application phase the system queries about specific information in connection with the project including:
a. as cost of the project,
b. technology to be used or developed in conjunction with the project.
c. community organization aspects that will he implemented in conjunction with the project
d. population impact (e.g., number of people impacted)
e. community contribution
f. long-term maintenance plan and costs
g. revenue model
h. visual aids and documents (e.g, photos, narrative files, spreadsheets, etc)
i. the background of the other parties involved

69. The system of claim 64 wherein the system comprises a module for receiving and processing progress reports and/or final results provided by the implementer. The reports are provided in a standardized format.

70. The system of claim 64 wherein the system allows participatory decision making.

71. The method of claim 54 wherein the projects are water related projects, development projects, health related projects; micro-credit projects, education-related projects.

72. The method of claim of 54 wherein the projects are micro-credit related projects.

73. The method of claim 54 wherein the projects are education related projects.

74. A computer implemented method of managing application for projects related to carbon exchange credits; wherein the method is effected through a peer-to-peer network and the method comprises:
(1) collecting information regarding each application;
(2) distributing the applications submitted to a subset of peers for review;
(3) allowing questions, answers, suggestions, and comments for each application;
(4) allowing the submission of a rating (a numerical set of scores and comments) by peers for each application;
(5) generating a report wherein said report contains:
(a) the project application;
(b) the questions and the responses;
(c) the rating by each reviewer; and
(d) a statistical analysis of all the ratings in combination with the ratings of the reviewer themselves.
